(19) United States
(12) Patent Application Publication
(10) Pub. No.: US 2007/0035404 A1
(43) Pub. Date: Feb. 15, 2007

(54) Stair deluge system - product and method

(76) Inventors: Saul Levine, Teaneck, NJ (US); Russell Arnold, Washingtonville, NY (US)

Correspondence Address: Mitchell P. Novick, Esq.;Law Offices Of Mitchell P. Novick, 66 Park Street, Montclair, NJ, 07042, US

(21) Appl. No.: 11/502,701

(22) Filed: Aug. 9, 2006

Related U.S. Application Data
(60) Provisional application No. 60/706,573, filed on Aug. 9, 2005.

(51) Int. Cl. G08B 17/12

(52) U.S. Cl. 340/577

(57) ABSTRACT

A fire suppression system for a staircase comprises a smoke detector, a fire suppression agent contained in a pressurized reservoir, a plurality of distribution means for distributing the fire suppression agent, a power source, a light source, a relay in communication with the smoke detector, the light source and the reservoir, and, in one embodiment, a manual release mechanism. The light source is activated upon a signal from the smoke detector, the manual release is activated by an occupant of the structure containing the staircase, causing the reservoir to release the fire suppression agent, which is discharged through the distribution means which have been positioned in a pattern customized for each staircase to effect suppression of a fire, enabling the occupants to utilize the staircase and exit the structure.

### CROSS-REFERENCES TO RELATED APPLICATIONS

This application claims the benefit of U.S. Provisional Application for Patent, Ser. No. 60/706,573, filed Aug. 9, 2005, the contents of which are hereby incorporated by reference in their entirety.

### FIELD OF THE INVENTION

Embodiments of the present invention relate to a system and method for fire suppression in a building, which building can be either a residential or a commercial structure. These embodiments relate to suppression of a fire or smoke condition in a stairway, allowing time for occupants of the building to escape therefrom.

### BACKGROUND OF THE INVENTION

Too frequently the news reports stories of people killed or injured because they were trapped on the second floor or other non-exit-level floor of a structure due to a fire that was burning in the stairwell and/or smoke that has filled the stairwell.

Stairwells have a chimney effect that attracts a fire and/or smoke from a fire. This invention is designed to allow people trapped on the 2nd floor of a burning building to manually release a fire retarding chemical to smother the fire in the stairwell and/or vacate the smoke from the stairwell for a time period (for example, 3-5 minutes) and allow the people to go down the stairs and exit the area.

Several references disclose systems for suppressing fires within stairwells. For example, Palmer (U.S. Pat. No. 4,054,084) discloses a system for keeping stairways of high-rise buildings clear of fire and smoke by using high speed fans activated by smoke detectors.

Jones (G.B. Patent Application No. 2,223,677 A) discloses a trapdoor that has a smoke alarm affixed to its' underside, the trap door designed to prevent smoke and fumes from passing up a stairway from a lower floor, to an upper floor of a building.

Dunlop et al. (U.S. Pat. No. 2,589,797) disclose a fire protection system for use in multistory buildings, specifically, a sprinkler system to spray water across the path of fumes from a fire. The spray is designed to form a curtain of water to deluge an area, such as a moving stairway.

Lau (U.S. Pat. No. 6,644,414 B1) discloses a life saving fire exit method and portable apparatus designed to enable people to transit safely through the apparatus to exit the building. The portable enclosure contains a container of water, an entrance that can be sealed, and water and baffles, thereby providing an air-lock type barrier which blocks the passage of smoke and gases, and an up/down staircase to go over the pool of water within the enclosure.

In U.S. Pat. App. Pub. No. 2004/0159448, Robinson, Jr. discloses a fire protection apparatus and method, the system comprising a series of bladders that are substantially filled with a non-flammable liquid by a manifold that is coupled to a source of the non-flammable fluid, and includes one or more nozzles that discharge the non-flammable liquid into each of the plurality of bladders.

Williams (G.B. Pat. App. No. 2,227,657 A) discloses a safety device for shutting off a floor of a building, which comprises a door positioned at the bottom of a stairwell. The door can be made either from a plastic, steel or a slow burning wood. The door is mounted on tracks attached to the wall, and is retained in the storage position by means of a pin and hinged springs, and a counterbalancing weight. The door is vertically translated between the use (down) position and the storage (up) position. The door can be activated by an alarm switch, and the door can be lowered at night to protect the residents of an upstairs area from a fire or intruder downstairs.

In U.S. Pat. No. 4,054,084, Palmer disclose a fire and smoke free system for high rise building stairways, which comprises a first fan that supplies a variable quantity of external air, in proportion to the number of entrance doors open, to the stair shaft when activated, and with a second fan directing the flow of air through the doorway of an entrance door when the entrance door is opened.

Watanabe et al. (U.S. Pat. No. 5,353,879, issued Oct. 11, 1994) discloses a door having a smoke reducing apparatus associated with it. The door includes a nozzle or plurality of nozzles, with a liquid source connected to the nozzle. The door includes a supply of pressurized water therein, with a surface active agent in the supply of pressurized water. The surface active agents function as a “de-smoking” agent, to help remove smoke particles from the air. Dusts in the exhaust gases are adsorbed onto the sprayed water droplets, and sedimented together with the water droplets into the water collector.

None of these references disclose a stairway deluge system that comprises a pressurized tank that holds the fire retardant fluid or chemical; smoke detectors to activate upon the presence of a sufficient quantity of smoke; a fire retardant fluid or chemical distribution system including piping and nozzles; a manual pull station; and an emergency light with a battery pack.

### BRIEF SUMMARY OF THE INVENTION

It is an object of the present invention to provide a fire suppression system that can suppress a fire or smoke condition in a stairway, and allow time for occupants of the building to escape.

Another object of the present invention is to provide a source of emergency lighting to direct occupants of the building to a location to actuate and release a fire retardant fluid or chemical from a pressurized storage tank.

An embodiment of the invention is a fire suppression system for a staircase that comprises a smoke detector, a fire suppression agent contained in a pressurized reservoir, a plurality of distribution means for distributing the fire suppression agent, a power source, a light source, a relay in communication with the smoke detector, the light source and the reservoir, and, in one embodiment, a manual release mechanism. The light source is activated upon a signal from the smoke detector, the manual release is activated by an occupant of the structure containing the staircase, causing the reservoir to release the fire suppression agent, which is discharged through the distribution means which have been positioned in a pattern customized for each staircase to effect suppression of a fire, enabling the occupants to utilize the staircase and exit the structure.

### BRIEF DESCRIPTION OF THE SEVERAL VIEWS OF THE DRAWING

FIG. 1 is a schematic of an embodiment of the present invention.

FIG. 2 is a schematic illustrating one example of how the sprinkler nozzles could be arranged over a staircase.

### DETAILED DESCRIPTION OF THE INVENTION

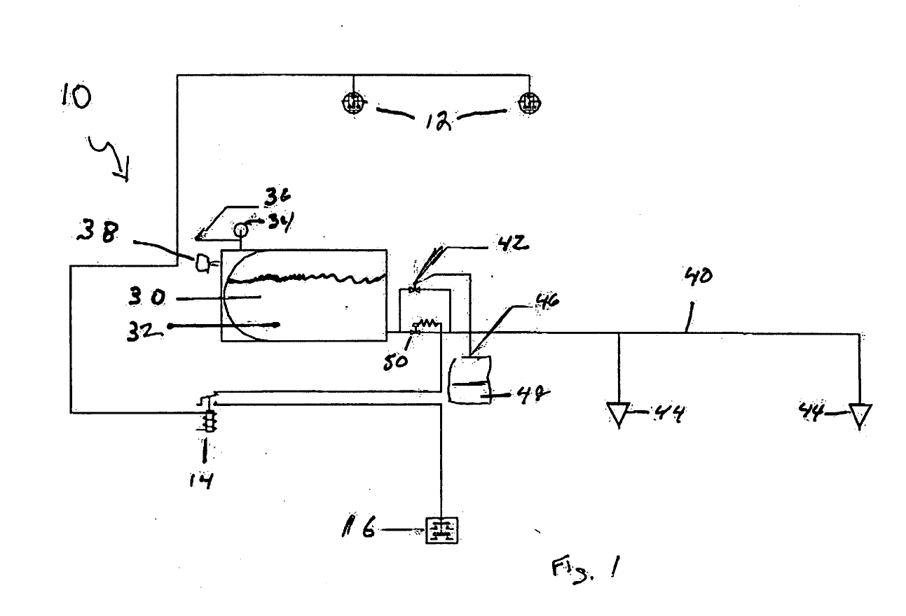

An embodiment of the present invention is schematically shown as a fire suppression system 10 (FIG. 1). In the embodiment illustrated, the system is designed for use within a structure such as a 2-story residential building, but it is to be understood that the system can be modified to be used within buildings having multiple floors, such as apartment buildings, high-rise buildings, various tall and large buildings, as well as commercial and industrial buildings of various heights.

The system 10 comprises one or more smoke detectors 12 in electrical communication with a relay 14 or a central processing unit. The smoke detector 12 is a conventional smoke detector, and can be of the photo-sensitive or ionization detector-type. One or more smoke detectors 12 are positioned near the top of the stairs, or as otherwise mandated by the local building and/or fire codes. In one embodiment of the present invention, the smoke detectors are provided with electrical power by “hard-wiring” into the building's electrical system, but smoke detectors operated by battery power could also be utilized. Relay 14 could be a single relay, or could be a microprocessor within a central processing unit of a computer or the like.

By means of example only, and not intended as any limitation, one example of a hard-wired smoke detector is sold under the brand name FIREX® (Registered trademark of Maple Chase Co, Downers Grove, Ill.), while battery-operated units such as those sold under the FIRST ALERT® brand (Registered trademark of First Alert Trust, Chicago, Ill.) or made by Kidde (Kidde IP Holdings Limited, Slough Berkshire, UK) could be utilized.

The relay 14 is in communication with a pull mechanism 16 which is generally positioned proximate the top of a stairway 18. The stairway 18 is a conventional stairway, having a bottom 20 and a top or landing 22. Depending upon how the building is constructed, stairway 18 may or may not be contained within a conventional stairwell. The stairway and the stairwell are of conventional construction, and will not be described in further detail. The stairway could also be an escalator or other form of moving stairs, and thus the term “stairway” as used within the context of the present specification, will be meant to include escalators and other forms of moving stairs known to those skilled in the art.

A reservoir or pressurized tank 30 contains a quantity of a fire retarding fluid or fire suppression agent 32. The fire retarding agent 32 can be water, a fire retardant chemical, or a mixture of water with one or more fire retardants. A surfactant may also be added to the mixture of water and fire retarding chemicals to increase the wettability of the mixture. A pressure gauge 34 displays the pressure inside the reservoir 30, and can be used to monitor the status of the system. A recharge valve 36 and a test valve 38 connected to the reservoir allows the unit to be refilled and recharged with the fire retardant fluid after the contents of the reservoir have been depleted, and for periodic maintenance and/or replenishment of the system. The specific pressure or pressure range of the system will vary from one installation to another, and will depend upon factors, such as, but not limited to, the size of the reservoir, the number of distribution nozzles, the distance between the reservoir and the distribution nozzles, and the overall size of the area to be protected.

Piping 40 connects the reservoir 30 with a valve 42 and the distribution nozzles 44 distributed in a pattern such that when the system is activated, the discharged fire retardant fluid or chemical is dispersed over the area of the stairwell sufficiently to suppress a fire and/or push away the smoke from the stairwell, without leaving areas of the stairwell that have not been treated by the discharged fire retardant mixture. The nozzle 44 can be any one of the conventional nozzles used in sprinkler systems employed in residential or commercial structures, but it is preferred to utilize nozzles that lack a fusible link. Where appropriate, or as required by code, such as, for example only, the building code or fire code, the piping 40 and the reservoir 30 are insulated using insulating material (not shown) that is applied thereto in a conventional manner.

An emergency light 46 is positioned proximate the top of the stairs, emergency light 46 being hard-wired into the building's electrical system and including a battery pack 48 to provide power in the event of an electrical failure. Such emergency lights are used routinely in commercial and residential structures, and for example only, sold by companies such as Intermatic (Intermatic Inc., Spring Grove, Ill.), Panasonic or others.

Operation

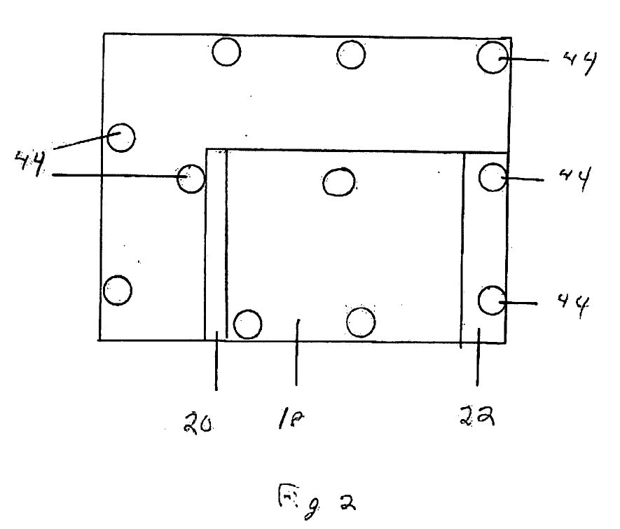

The system operates as follows:
(A) Upon activation of a smoke detector 12 due to the presence of smoke, the smoke indicating the presence of either a fire or other type of smoke condition, the following events occur:
   (1) The emergency light 46 illuminates after receiving a signal from smoke detector 12. The emergency light is actuated after receiving a signal from the smoke detector 12, which signal can be either an electrical signal transmitted through relay 14, or upon response to the audio signal emitted by smoke detector 12. This illumination allows the occupants to find the stairwell and the manual pull station 16 even if there is a power outage. The emergency light 46 will generally utilize the building's power source for operation, but the battery pack 48 will supply power in the event of a power failure.
   (2) A solenoid valve 50 opens, which in turn permits the system to be armed. A manual backup release 52 is provided in case the smoke detection release fails.
(B) After an occupant or a group of occupants gathers at the top of the stairs, the manual pull station 16 is pulled. This action releases the fire retardant fluid or chemicals 32 from the pressurized tank 30 into the distribution piping, enabling the fire retardant fluid or chemicals to flow to the multiple nozzles 44. The nozzles are arranged such that the fire retardant fluid or chemicals 32 is discharged in a pattern that is customized for each stair layout to smother the fire immediately on and around those stairs and/or provide a mass of fire retardant fluid or chemical that will push all the smoke down and out of the stairwell (see FIG. 2). This smothering should provide a 3-5 minute fire free route down the stairs, enabling the occupants to flee the building using the stairs, or other means of egress.
   Miscellaneous

Any one of a variety of fire retardant agents can be employed within the system, and these are commercially available from a number of suppliers. Some parameters for choosing the fire retardant agent are:
(a) Will have some adhesion quality for fluid or chemical to stick to the surfaces;
(b) Provide some traction on the stairs;
(c) Be non-toxic to humans; and
(d) Should hold its composition for a minimum of 5 years.
   Variations

Variations on this invention include, without limitation:
(1) a system and method for stairways of a size other than 2 floors, with adjustments to the components if necessary to accommodate such stairways;
(2) a system and method for use in stairways which ascend to the exit level, in which case, the directional terms “top”, “down”, “descend”, and the like, would be replaced, respectively, with “bottom”, “up”, “ascend”, etc.
(3) a system and method which may be partially or completely automatic. In an automatic system, for example, relay 14 could be replaced by a fully automatic relay, and the manual pull mechanism 16 could function as a backup to this automatic system; and
(4) a shaped ceiling molding or a drop molding (for example, without limitation, in the three- to five-inch range) could be placed around the stairwell opening on the ground floor that will further slow down the return of smoke into the treated stairwell. Drop moldings are well known in the relevant art. This molding could include one or more distribution nozzles for the fire retardant agent.

Therefore, although the present invention has been described with a certain degree of particularity, it is to be understood that the present disclosure has been made only by way of illustration, and that numerous details of construction and arrangement of parts may be resorted to without departing from the spirit and scope of the invention.

We claim:

1. A fire suppression system for a staircase, the system comprising:
a fire suppression agent;
a reservoir to contain the fire suppression agent therein;
a distribution means for distributing the fire suppression agent, the distribution means being in flow communication with the reservoir;
a detection means for detecting a fire or smoke condition; and
an activation means in communication with the detection means and the distribution means to activate the distribution means upon detection of a fire or smoke condition.

2. The system as described in claim 1, wherein:
the reservoir comprises means for being pressurized to a specified pressure range, the reservoir further comprising a pressure gauge, a discharge valve and a recharge valve;
the distribution means comprises a plurality of means for distributing the fire suppression agent;
the system further comprises:
a power source in electrical communication with the system;
a light source, the light source being in communication with the detection means;
a relay in communication with the detection means, the light source, and the reservoir; and
a manual release mechanism;
the light source being activated upon a signal from the detection means that the fire or smoke condition has been detected; and
the manual release being activated, causing the relay to signal the reservoir to release the fire suppression agent through the discharge valve.

3. The system as described in claim 2, wherein the light source further comprises a backup power device.

4. The system as described in claim 3, wherein the backup power device comprises a battery.

5. The system as described in claim 3, wherein the distribution means are positioned in a pattern to cover the area of the staircase, and wherein the pattern of the distribution means is customized for the staircase.

6. The system as described in claim 5, wherein the distribution means is a spray nozzle.

7. The system as described in claim 5, wherein the distribution means does not include a fusible link.

8. The system as described in claim 6, wherein the means for detecting fire is a smoke detector.

9. The system as described in claim 8, wherein the reservoir further comprises insulation.

10. The system as described in claim 1, wherein:
the reservoir comprises means for being pressurized to a specified pressure range, the reservoir further comprising a pressure gauge, a discharge valve and a recharge valve;
the distribution means comprises a plurality of means for distributing the fire suppression agent;
the system further comprises:
a power source in electrical communication with the system;
a light source, the light source being in communication with the detection means; and
an automatic relay in communication with the detection means, the light source, and the reservoir;
the light source being activated upon a signal from the detection means that the fire or smoke condition has been detected; and
the relay being activated, thereby signaling the reservoir to release the fire suppression agent through the discharge valve.

11. The system as described in claim 10 further comprising a manual release mechanism, wherein actuation of the manual release mechanism signals the discharge valve to release the fire suppression agent.

12. The system as described in claim 11, wherein the light source further comprises a backup power device.

13. The system as described in claim 12, wherein the distribution means are positioned in a pattern to cover the area of the staircase, and wherein the pattern of the distribution means is customized for the staircase.

14. The system as described in claim 13, wherein the distribution means is a spray nozzle.

15. A method for suppressing a fire or smoke condition in a staircase, the method comprising the steps of:
(A) utilizing a suppression system, the system comprising:
a fire suppression agent;
a reservoir to contain the fire suppression agent therein;
a distribution means for distributing the fire suppression agent, the distribution means being in flow communication with the reservoir;
a detection means for detecting a fire or smoke condition; and
an activation means in communication with the detection means and the distribution means to activate the distribution means upon detection of a fire or smoke condition.
(B) sending a signal from the detection means that the fire or smoke condition has been detected;
(C) activating the distribution means; and
(D) releasing the fire suppression agent to suppress the fire or smoke condition.

16. The method as described in claim 15, wherein:
the reservoir comprises means for being pressurized to a specified pressure range, the reservoir further comprising a pressure gauge, a discharge valve and a recharge valve;
the distribution means comprises a plurality of means for distributing the fire suppression agent;
the system further comprises:
a power source in electrical communication with the system;
a light source, the light source being in communication with the detection means;
a relay in communication with the detection means, the light source, and the reservoir; and
a manual release mechanism;
the activating step (C) further comprising activating the manual release;
the releasing step (D) further comprising release through the discharge valve; and
the method further comprises:
(E) activating the light source upon a signal from the detection means that the fire or smoke condition has been detected.

17. The method as described in claim 15, wherein:
the reservoir comprises means for being pressurized to a specified pressure range, the reservoir further comprising a pressure gauge, a discharge valve and a recharge valve;
the distribution means comprises a plurality of means for distributing the fire suppression agent;
the system further comprises:
a power source in electrical communication with the system;
a light source, the light source being in communication with the detection means; and
an automatic relay in communication with the detection means, the light source, and the reservoir;
the activating step (C) further comprising activating the relay, thereby signaling the reservoir to release the fire suppression agent through the discharge valve;
the releasing step (D) further comprising release through the discharge valve; and
the method further comprises:
(E) activating the light source upon a signal from the detection means that the fire or smoke condition has been detected.

18. The method as described in claim 17, wherein:
the system further comprises:
a manual release mechanism; and
the activating step (C) further comprising activating the manual release mechanism in the event of failure of the automatic relay to activate, thereby signaling the reservoir to release the fire suppression agent through the discharge valve.

19. A building staircase suitable for use during a fire or smoke condition, the staircase comprising:
means for traversing the staircase;
a reservoir capable of containing a fire suppression agent therein;
a distribution means capable of distributing the fire suppression agent within the staircase, the distribution means being in flow communication with the reservoir;
the fire suppression agent being at least partially distributed within the staircase; and
a light capable of adding illumination to the staircase.
